(19) United States
(12) Patent Application Publication
(10) Pub. No.: US 2003/0188150 A1
(43) Pub. Date: Oct. 2, 2003

(54) System and method for media authentication

(75) Inventors: Akira Ohkado, Yokohama-shi (JP); Satoko Tanagawa, Yamato-shi (JP)

Correspondence Address: Samuel A. Kassatly, 6819 Trinidad Drive, San Jose, CA, 95120-2056, US

(73) Assignee: International Business Machines Corporation, Armonk, NY

(21) Appl. No.: 10/396,939

(22) Filed: Mar. 24, 2003

(30) Foreign Application Priority Data
Mar. 28, 2002 (JP) 2002-093207

(51) Int. Cl. H04L 9/00

(52) U.S. Cl. 713/150

(57) ABSTRACT

A system allows a user to specify restriction categories for media provided by a content provider. The media can be rated, guaranteed, and marked with a digital watermark to verify that the media matches the restrictions placed by the user. This process may also be used by a content provider to verify the status of customer's accounts, restricting media to those customers whose accounts are paid. The system calculates a digest value of content provided by a content provider on a terminal of the content provider, and generates control information including the calculated digest value. The digest value included in the control information is compared with a digest value calculated on a terminal of the user. This comparison is used to control the reproduction of the content on the user's terminal. Content reproduction control is achieved by using the key information on the user's terminal to determining whether the control information is valid. If the digest values are identical, and the control information is determined to be valid based on the key information, the user will be able to reproduce the content.

### PRIORITY CLAIM

The present application claims the priority of Japanese patent application No. 2002-093207, titled “Method, Computer Apparatus, and Program for Providing Content and Method for Reproducing Content,” which was filed on Mar. 28, 2002, and which is incorporated herein by reference.

### FIELD OF THE INVENTION

The present invention relates to a method for proving contents such as still images, motion pictures, and sound. More specifically, the present invention pertains to a system for allowing users to specify restrictions on media viewing, and for authenticating those restrictions. In particular, the present system provides a media authentication and watermark system in conjunction with a method for providing a third party guarantee of the restriction or media rating.

### BACKGROUND OF THE INVENTION

The number of sites provided on the Web is increasing every year and users can freely access a wide variety of contents. However, many harmful or hate sites are also displayed on the Web and, in some applications of computers, restrictions are placed on displaying contents. Parents, schools, and companies often restrict the display of contents for educational or business purposes.

In addition, users demand the ability to block access to risky sites in order to avoid the influence of viruses in recent years.

Traditionally, these restrictions on the display of contents have been placed by using filtering software or security settings of web browsers.

However, because filtering software performs filtering by searching a content for certain tags or words, it strongly depends on the conscience of the creator of the content and does not necessarily provide desired filtering. Furthermore, filtering software cannot preclude image data and audio data such as music.

Web browser security settings are set by a user. Accordingly, these settings provide limited performance of restricting the display of contents.

Furthermore, unauthorized persons with intent and ability to hack into a web site can tamper with the contents of that site. If a content on an otherwise safe site is maliciously altered, the user cannot do much to block the display of that content.

What is therefore needed is a system and associated method that effectively restrict content viewing and listening. The need for such system and method has heretofore remained unsatisfied.

### SUMMARY OF THE INVENTION

The present invention satisfies this need, and presents a content display restriction system, a computer program product, and an associated method (collectively referred to herein as “the system” or “the present system”). Content could include, for example, still picture, audio, motion picture, text, or other media provided by a source such as an Internet site or cable television, to a user such as a web browser. As used herein the media source includes, for example, the content provider, and the user includes, for example, the media recipient.

The present system calculates a digest value of content provided by a content provider on a terminal of the content provider and generates control information including the calculated digest value. The control information and content data are provided to a user. In addition to the control information and content data, key information for controlling the reproduction of the content is provided to the user.

The digest value included in the control information is compared with a digest value calculated on a terminal of the user. This comparison is used to control the reproduction of the content on the user's terminal. Content reproduction control is achieved by using the key information on the user's terminal to determining whether the control information is valid.

If the digest values are identical to each other and the control information is determined to be valid based on the key information, the user can reproduce the content.

The control information and content data may be provided from the content provider to the user through data transmission over a network such as the Internet. Alternatively, they may be output from the content provider's terminal to a storage medium such as a CD-ROM, which then may be delivered by the content provider to the user. The control information and content data may then be read from the storage medium on the content user's terminal.

The creator of a content and the issuer of control information at a content provider may be the same. However, if the content is rated and guaranteed, it is desirable that they be separate parties: a first content provider creating the content and a second content provider different from the first content provider to rate and guarantee the content.

In the latter case, the control information is generated, encrypted, and output on a terminal of the second content provider different from the creator of the content and provided to the first content provider. On the first content provider's terminal, the control information provided from the second content provider is added to the content data and the content data with the control information is output. Decryption key data for decrypting the encrypted control information is output on the second content provider's terminal and provided to the user as key information.

Because the control information is encrypted, the first content provider cannot alter the control information. Only the user to whom both of the encrypted control information and decryption key are provided can decrypt the control information.

In addition, control information can be generated on the content creator's terminal and encrypted with an encryption key provided from the second content provider. Decryption key data for decrypting the encrypted control information can be output on the second content provider's terminal as key information. This arrangement is viable if the creator of content is considered trustworthy by the second content provider that rates the content.

The present system may be viewed as a computer used by a party that rates contents. In the computer, a control information generator produces control information for determining whether reproduction of a content obtained from an external source over a network should be allowed.

The control information is encrypted by an information encryptor and transmitted by an information transmitter to a terminal of a content publisher over the network. Encryption key data used for encrypting the control information and decryption key data used for decrypting the encrypted control information are stored in a key information storage in the computer.

In this configuration, the content publisher adds the encrypted control information to content data and publishes the content data on the network. A receiver of the content can obtain the content data and control information presented on the network in addition to the decryption key stored in the key information storage of the computer used to decrypt the encrypted control information. The content receiver can restrict the reproduction of contents by setting its terminal so that contents can be reproduced only if the control information can be decrypted.

A digest value calculator of the computer calculates a digest value of a content. The control information generator can include the calculated digest value in the control information. At the receiver of the content, a digest value of the content is calculated and the calculated value is compared with the digest value included in the control information to determine whether the content has been modified by an unauthorized third party.

The present system may be viewed as a computer used at a content publisher. In the computer, a digest value calculator calculates a digest value of a content to be published, a control information generator generates control information including the digest value for controlling whether the reproduction of a content is allowed, and an information encryptor encrypts the control information by using an encryption key received from an external source.

The encryption key may be issued by a party such as a content rater, for example. A content delivery unit of the computer delivers the content data along with the encrypted control information to a content user.

The content delivery unit may add the encrypted control information as a digital watermark to the content data. The digital watermark may be a visible image displayed along with the content.

In another embodiment, the present system generates guarantee information for guaranteeing a content obtained from an external source over a network, encrypts the guarantee information, and transmits the encrypted guarantee information to a terminal of the publisher of the content over the network. The present system may also provide data on a decryption key for decrypting the encrypted guarantee information to a terminal of a registered content acquirer. Furthermore, the present system may calculate the digest value of the content. The step of generating guarantee information may generate guarantee information that includes the digest value.

If the guarantee information is divided into a plurality of categories, the present system may send identification for determining whether guarantee information of a certain category among the plurality of categories is valid.

The present system may also send an identification update to a content acquirer who sends identification. This step is effective in a case where a content fee is billed on a regular basis, where regular update is required to identify users who pay the fee.

In another embodiment, the present system reproduces content on a terminal of a content user. According to the present system, content data and control information for controlling whether the reproduction of the content should be allowed are received over a network. If verification information issued by a third party that is not the provider or user of the content corresponds to the control information, the content is reproduced.

Alternatively, control information encrypted with an encryption key issued by a third party may be received and, if the control information received can be decrypted with a decryption key provided by the third party as verification information, the content may be reproduced.

The content control information received along with the content data may contain the digest value of the content. The digest value of the content received is calculated and, if the calculated digest value matches the digest value contained in the control information, the content can be reproduced.

On the user's computer, the present system obtains content data and encrypted control information over a network from a terminal of content publisher, This encrypted control information is used to control whether the reproduction of the content should be allowed. In addition, the present system decrypts the control information with a decryption key stored in a program data storage area, determines based on information contained in the decrypted control information whether the reproduction of the content is allowed, and reproduces the content based on the result of the determination.

The present system operating on the user's computer may obtain control information having a particular authentication category. In addition, an authentication category may be provided when the present system determines whether reproduction of the content is allowed. If the two authentication categories match, the present system reproduces the content.

In this case, the control information has a plurality of authentication categories such as “no one under 12 allowed to view or listen,” “no one under 15 allowed to view or listen,” and “no one under 18 allowed to view or listen”. If the authentication category included in control information provided along with the content corresponds to the authentication category specified by the content user, the content is reproduced. For example, a user may specify the authentication category “no one under 12 allowed to view or listen.” Consequently, if the content is not of the authentication category “no one under 12 allowed to view or listen,” the content is reproduced. For cable television services, authentication categories may be changed according to charges (viewing fees) to change the number of channels (contents) available to users (content acquirers) according to the authentication category of the users.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which a method for providing and reproducing content system of the present invention can be used;

FIG. 2 is a process flow illustrating a method for generating a content ID at content rater by the system of FIG. 1;

FIG. 3 is a process flow chart illustrating a method for reproducing a content at a user site by the system of FIG. 2;

FIG. 4 is a schematic illustration of another embodiment in which a method for providing and reproducing content system of the present invention can be used;

FIG. 5 is a process flow chart illustrating a method for generating a content ID at a content rater by the system of FIG. 4;

FIG. 6 is a process flow chart illustrating a method for reproducing a content at a user site by the system of FIG. 4;

FIG. 7 is a schematic illustration of still another embodiment in which a content display restriction system of the present invention can be used;

FIG. 8 is a process flow chart illustrating a method for generating a content ID at a content rater by the system of FIG. 7;

FIG. 9 is a process flow chart illustrating a method for reproducing a content at a user site by the system of FIG. 7;

FIG. 10 is a schematic illustration of another embodiment in which a content display restriction system of the present invention can be used;

FIG. 11 is a process flow chart illustrating a method for generating a content ID at content creator by the system of FIG. 10;

FIG. 12 is a process flow chart illustrating a method for generating a guarantee at a content rater by the system of FIG. 10;

FIG. 13 is a process flow chart illustrating a method for reproducing a content at a user site by the system of FIG. 10;

FIG. 14 is comprised of FIGS. 14A, 14B, 14C, and 14D, and illustrates exemplary authenticated contents provided to the user according to the present invention;;

FIG. 15 is comprised of FIGS. 15A and 15B, and shows an example of a content reproduction method of the present invention; and

FIG. 16 is comprised of FIGS. 16A, 16B, 16C, and 16D, and shows examples of screen panels displayed on a user terminal during selection of guarantees.

### DETAILED DESCRIPTION OF PREFERRED EMBODIMENTS

The following definitions and explanations provide background information pertaining to the technical field of the present invention, and are intended to facilitate the understanding of the present invention without limiting its scope:

Hash Function: An algorithm that turns a variable-sized amount of text into a fixed-sized output (hash value). Hash functions are used in creating digital signatures and hash tables. Hash functions are known as “cryptographic hash functions.”

Hash Value: The fixed-length result of a one-way hash function.

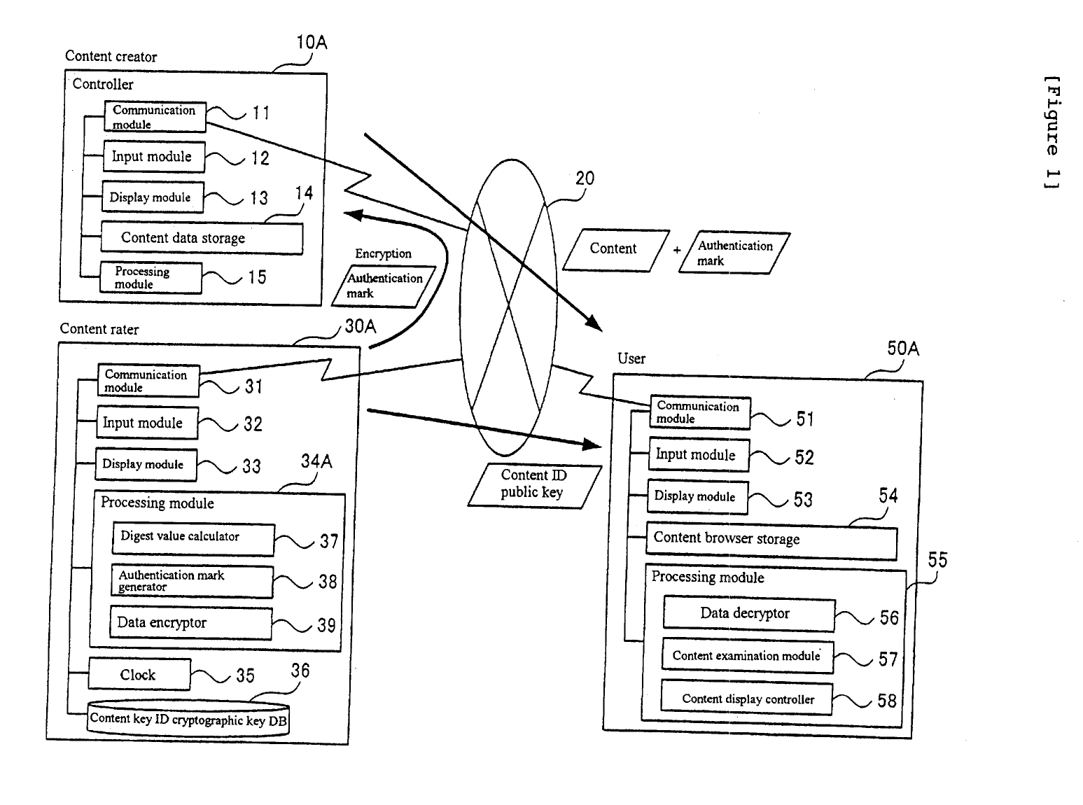

FIG. 1 illustrates a general configuration of a content display restriction system. As shown in FIG. 1, content creator (first content provider), who is the provider and/or publisher of a content publishes contents such as still images, motion pictures, sound (audio data), and/or text in PDF (Portable Document Format) created on a network 20 such as the Internet through a terminal 10A of the content creator.

The content creator is granted authentication for the content from a content rater (second content provider) and receives an authentication mark from a terminal 30A of the content rater over the network 20 that indicates that the authentication is granted. When accessed by a user's terminal 50A, the content creator's terminal 10A attaches an authentication mark to a specified content and sends it to the user's terminal 50A. The user's terminal 50A verifies the content based on information contained in the authentication mark received along with the content and outputs the content as a display or audio reproduction only if the content is validated.

The content rater may be an organization such as a PTA, an institute such as a school or government agency that aims to protect children against harmful sites, or a publisher, a provider or a portal site operator that wants to provide safety- or quality-guaranteed content. The content rater is a content provider from the viewpoint of the content user. it is a third party from the viewpoint of the content creator and user.

On the other hand, the user, which is a content user or acquirer, may be a public facility such as a school or municipal office or a family or company including minors.

The content creator's terminal 10A may be a personal computer or workstation that comprises a communication unit (content data delivery unit) 11 responsible for sending and receiving data over a network 20, an input module 12 such as a keyboard and mouse, a display module 13 such as a monitor, a content data storage 14 such as a hard disk driver for storing content data created, and a processing module 15 implemented by a CPU and memory for performing processes according to a given program in response to an input from the input module 12.

Content data stored in the content data storage 14 may be data created on the content creator's terminal 10A or other terminals.

The content rater's terminal 30A may be a PC or workstation that comprises a communication unit (information transmitter) 31 responsible for sending and receiving data over the network 20, a input module 32 such as a keyboard and mouse, a display module 33 such as a monitor, a processing module 34A implemented by a CPU and memory for processing processes according to a predetermined program in response to an input from the input module 32, a clock 35 for keeping dates and time, and a content key ID cryptographic key database (database or key information storage) 36 for storing data on secret and public keys used in encrypting and decrypting content Ids. The content key ID cryptographic key database 36 will be described later.

The processing module 34A comprises a digest value calculator 37 for calculating the digest value of a content, an authentication mark generator (control information generator) 38 for generating an authentication mark to be attached to the content, and a data encryptor (information encryptor) 39 for encrypting data to be sent from the communication module 31.

The digest value of a content is a digitization of a characteristic pattern generated from original data for proving that the data to be transmitted is correct. It may be a hash value, for example. A hash value is generated by scrambling data (long data) representing a content by means of a hash function and compressing the data to produce a value of a fixed length (128 bits, for example).

An authentication mark is data attached to content data, rather than a visible symbol or mark.

The user's terminal 50A may be a PC, cellular phone, or an electric appliance having Web functionality that comprises a communication module 51 responsible for sending and receiving data over a network 20, an input module 52 such as a keyboard and mouse, a display module 53 such as a monitor, a content browser storage 54 such as an HDD for storing a content browser, which will be described later, and a processing module 55 implemented by a CPU and memory fur executing processes according to a given program in response to an input from the input module 52.

The content browser is provided by a content rater (or a third party) for pay or free when the content display restriction system is used. It may be a plug-in program that plugs into a program such as a browser that has a content browsing function, or a program that by itself displays a content. A user obtains the content browser beforehand over the network 20 or through a storage medium such as a CD-ROM containing the content browser and installs it in the user's terminal 50A. Consequently, the content browser is stored in the content browser storage 54. The content browser may be provided for free or pay.

The processing module 55 comprises a data decryptor 56 for decrypting encrypted data sent from the content creator's terminal 10A, a content examination module 57 for examining whether a content is valid based on the digest value of the content, and a content display controller 58 for controlling display of the content based of the result of the examination.

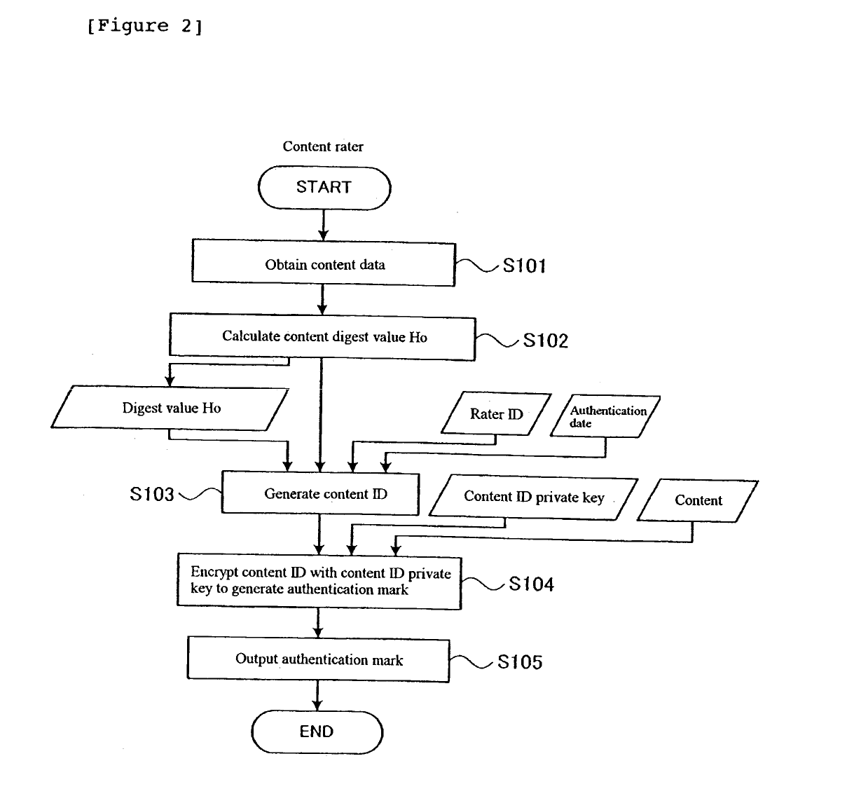

The method of the content display restriction system is illustrated by the process flow chart of FIG. 2.

First, a content rater searches through contents provided on an external network 20 on the content rater's terminal 30A. If the content rater finds a content that meets predetermined criteria set by the content rater, it starts a process for adding an authentication mark to that content (of course, the content rater may add the authentication mark to the content on a request from the creator of the content).

Content data (D) to be processed is obtained on the content rater's terminal 30A through the communication module 31 and stored in memory (step S101). The memory is not shown in FIG. 1.

At step S102, the digest value calculator 37 in the processing module 34A calculates the digest value (hash value) Ho of the obtained content data (D), as follows:

Ho=hash (D),

where hash is a computation expression for calculating the digest value.

Then, the authentication mark generator 38 in the processing module 34A generates a content ID (Did), which is control and guarantee information (step S103).

The content ID (Did) comprises a digest value Ho, ID (Aid) of the rater that rates the content, and information including the authentication date (and possibly time) when the content was authenticated through rating.

The content ID (Did) generated is encrypted by the data encryptor 39 in the processing module 34A by using a computation expression S to produce an authentication mark (Ke) (step S104). The content ID (Did) is encrypted by using a content ID private key (KpriA) pre-stored in the content key ID cryptographic key database 36 is paired with a content ID public key (KpubA):

Ke=S_{KpriA} (Did).

Next, the communication module 31 in the content rater's terminal 30A outputs the authentication mark (Ke) data to the content creator's terminal 10A over the network 20 (step S105).

When the authentication mark (Ke) data is received at the communication module 11 in the content creator's terminal 10A over the communication network 20, it is attached to the content data (D) automatically or by a predetermined operation by the content creator and is stored in the content data storage 14.

After the content is thus authenticated by the content rater, the content creator presents that content (hereinafter called the “authenticated content” as appropriate) on the network 20.

A user, on the other hand, uses a user's terminal 50A to access the authenticated content published on the network 20. For the user to display the authenticated content on the user's terminal 50A, the user must obtain a content browser from the content rater and install it in the user's terminal 50A beforehand. The content browser includes a content ID public key (KpubA) for decrypting the content ID as described above. The content public key (KpubA) is one stored as a decryption key in the content key ID cryptographic key database 36 of the content rater's terminal 30A paired with the content ID private key (KpriA).

When the content creator's terminal 10A is accessed by the user's terminal 50A over the network 20, it sends the authenticated content through the communication module 11. The authenticated content is the content data (D) to which an authentication mark (Ke) data is attached, stored in the content data storage 14.

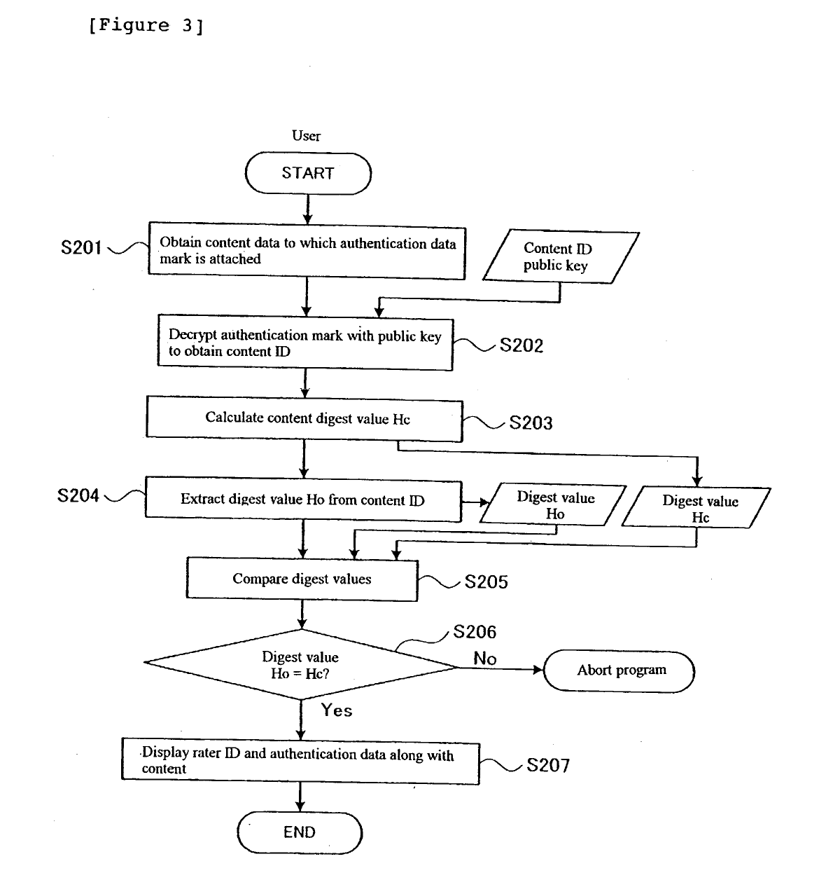

The process of receiving and authenticating content at a user's terminal 50A is described by the process flow chart of FIG. 3. The communication unit in the user's terminal 50A receives (obtains) the content data (D) to which the authentication mark (Ke) data is attached and temporarily stores it in memory (step S201). The memory is not shown in FIG. 1.

When the user's terminal receives the content data (D), the content browser is activated either automatically or by the user through an activation operation. The processing module 55 then performs the following process.

The data decryptor 56 decrypts the authentication mark (Ke) data attached to the content data (D) by using the content ID public key (KpubA) included in the content browser as well as a computation expression V to obtain the content ID (Did) (step S202):

Did=V_{KpubA} (Ke).

If the content ID public key (KpubA) is not valid, the remaining part of the process cannot be performed and therefore the content cannot be displayed. That is, if the content ID public key (KpubA) does not correspond to the content ID private key (KpriA), which is the encrypted authentication mark (Ke), the authentication mark (Ke) data cannot be decrypted. If the content cannot be displayed, the process may be ended and a message may be displayed indicating that the content cannot be displayed. The content ID public key (KpubA) functions as control information, key information, and verification information for controlling whether the reproduction of the content is allowed.

The user may inquire of the content rater's terminal 30A through the network 20 whether the rater ID (Aid) and authentication date included in the content ID are valid. After successful completion of the inquiry, the process may proceed to the subsequent steps. On the other hand, if it cannot be determined that they are valid, the process is aborted and the content is not displayed.

Next, the content examination module 57 calculates the digest value (hash value) Hc of the content data (D) (step S203).

The content examination module 57 also extracts the digest value Ho contained in the content ID (Did) (step S204) and compares it with the digest value Hc calculated at step S203.

If at step S206 the digest value Hc calculated is equal to the digest value Ho contained in the content ID (Did), the content received on the user's terminal 50A has not been altered by an unauthorized third party. Therefore, the content display controller 58 displays the content on the display module 53 based on the content data (D) (if the content is audio data, the audio data is output from speakers, not shown in FIG. 1.) The rater ID (Aid) and authentication date contained in the content ID (Did) may be displayed together with the content (step S207).

If it is determined at step S206 that the calculated digest value Hc is not equal to the digest value Ho contained in the content ID (Did), the content received on the user's terminal 50A may be different from the content rated at the content rater. That is, it may have been altered by an unauthorized third party. Therefore, the content display controller 58 terminates the browser without displaying the content.

According to the arrangement described above, the user's terminal 50A can display contents authenticated by the content rater. In addition, it is determined whether contents have been altered by an unauthorized third party and only the contents that have not been altered by an unauthorized third party are displayed. Thus, the user can obtain valid contents with security.

Because the user cannot display contents unless he or she has a content browser including a public key, content creators or content raters can restrict viewing or listening. Consequently, content creators and content raters can present their contents only to users who have registered themselves with the content creators or raters and collect viewing or listening fees without omission.

The configuration also improves user convenience because users can use a content browser containing a public key to display contents without knowing that the authentication of the contents is occurring and without having to perform operations such as the input of a password for displaying them.

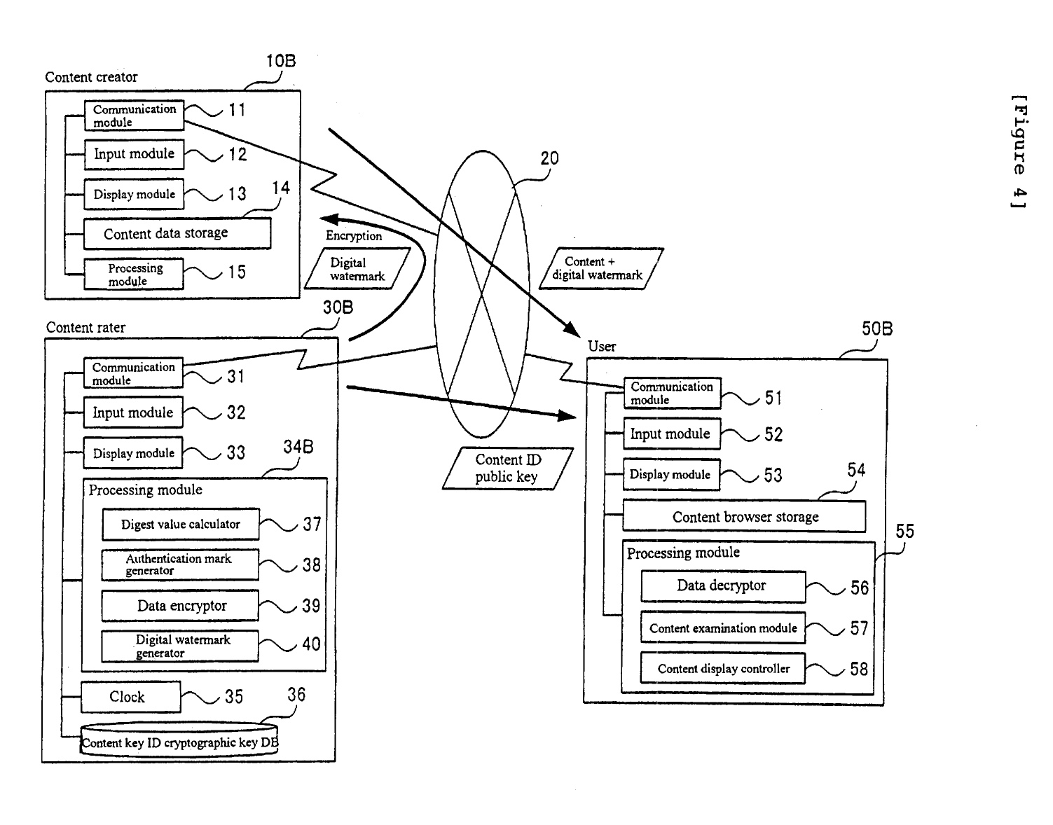

Another embodiment of the present invention, as shown in FIG. 4, operates as a content restriction system. This embodiment uses a digital watermark instead of the authentication mark described with respect to the previous embodiment. The same components in this embodiment as those in the previous embodiment will be labeled with the same reference numbers and the description of those components will be omitted.

FIG. 4 illustrates a general configuration of a content display restriction system.

As shown in FIG. 4, a content creator presents a created content on a network 20 such as the Internet through a terminal 10B of the content creator. The content creator receives digital watermark data indicating that a content is authenticated by a content rater from a terminal 30B of the content rater over the network 20. When the content creator's terminal 10B is accessed by a terminal 50B of a user, it sends content data in which the digital watermark is embedded to the user's terminal 50B. The user's terminal 50B verifies contents based on the information contained in the digital watermark embedded in the contents received. Only validated contents are output as a display or sound reproduction.

The content creator's terminal 10B comprises a communication module 11, an input module 12, a display module 13, a content data storage 14, and a processing module 15.

The content rater's terminal 30B comprises a communication module 31, an input module 32, a display module 33, a processing module 34B, a clock 35, and a content key ID cryptographic key database 36.

The processing module 34B comprises a digital watermark generator (control information generator) 40 for generating a digital watermark to be embedded in a content, in addition to a digest value calculator 37, authentication mark generator 38, and a data encryptor 39.

The digital watermark generator 40 performs a process for generating authentication image data in which an authentication mark used in the first embodiment described above is embedded as a digital watermark.

The user's terminal 50B comprises a communication module 51, an input module 52, a display module 53, a content browser storage 54, and a processing module 55.

The processing module 55 comprises a data decryptor 56, a content examination module 57, and content display controller 58.

To display content in a content display restriction system, a content rater searches through contents presented on the network 20 on the content rater's terminal 30B. If it founds a content that meets predetermined criteria set by the content rater, it starts a process for assigning an authentication mark to that content.

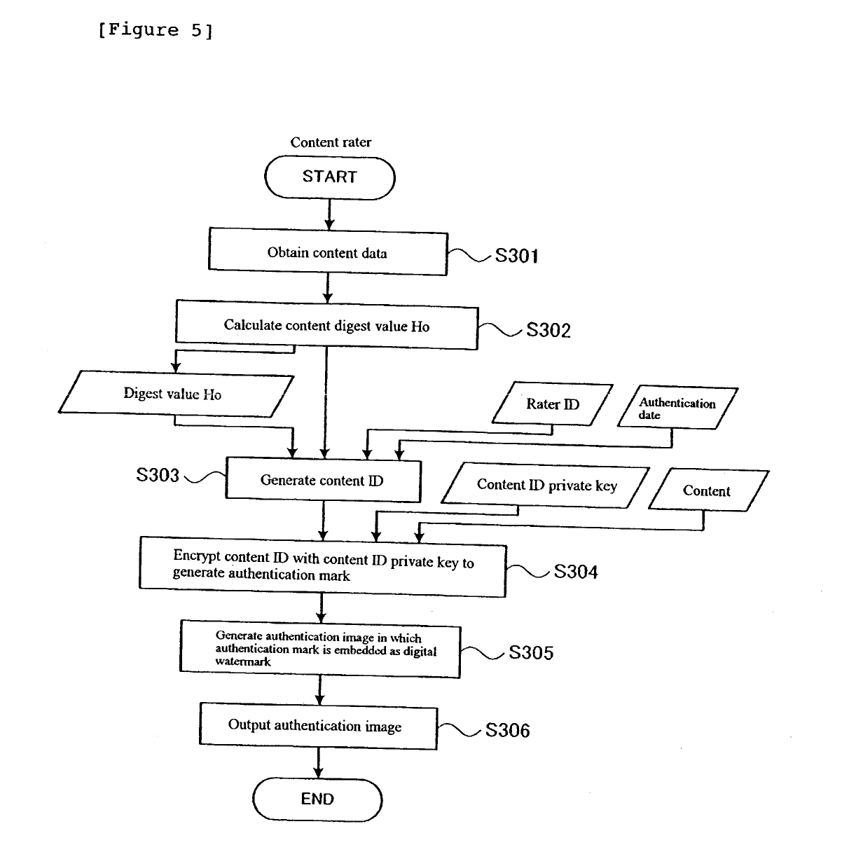

FIG. 5 is a process flow chart illustrating a method of operation of the content display restriction system of FIG. 4. Content data (D) to be processed is obtained through the communication module 31 and stored in memory, not shown, in the content rater's terminal 30B (step S301).

The digest value calculator 37 in the processing module 34B calculates the digest value (Ho) of the content data (D) obtained (step S302):

Ho=hash (D),

where hash is a computation expression calculating the digest value.

The authentication mark generator 38 in the processing module 34B uses information including the digest value (Ho), an rater ID (Aid) of the rater that has rated the content, and the authentication date on which the content has been authenticated to generate a content ID (Did) (step S303).

The content ID (Did) generated is encrypted by the data encryptor 39 in the processing module 34B by using a content ID private key (KpriA) and calculation expression S to generate an authentication mark (Ke) (step S304):

Ke=S_{KpriA} (Did).

The digital watermark generator 40 generates an authentication image in which the authentication mark (Ke) data is embedded as a digital watermark (step S305). If the content is a still image or motion picture displayed on the display module 53 of the user's terminal 50B, the authentication image may be an image such as a visible symbol mark displayed on or around the content. The authentication mark (ke), which is the digital watermark, is embedded in this authentication image.

In the content rater's terminal 30B, authentication image data in which the authentication mark (Ke) data is embedded as the digital watermark is sent from the communication module 31 over the network 20 to the content creator's terminal 10B (step S306).

When the communication module 11 in the content creator's terminal 10B receives the authentication image data over the network 20, the authentication image data is attached to the content data (D) and stored in the content data storage 14 automatically or by a predetermined operation performed by the content creator.

After the content is authenticated by the content rater, the content creator presents the content (hereinafter called the “authenticated content”) on the network 20.

A user uses a terminal 50B to access the authenticated content presented on the network 20. For the user to display the authenticated content on the user's terminal 50B, a content browser must be installed in the user's terminal 50B beforehand. The content browser includes a content ID public key (KpubA) for decrypting the content ID described above.

When the content creator's terminal 10B is accessed by the user terminal 50B over the network 20, the authenticated content stored in the content data storage 14 is sent through the communication module 11.

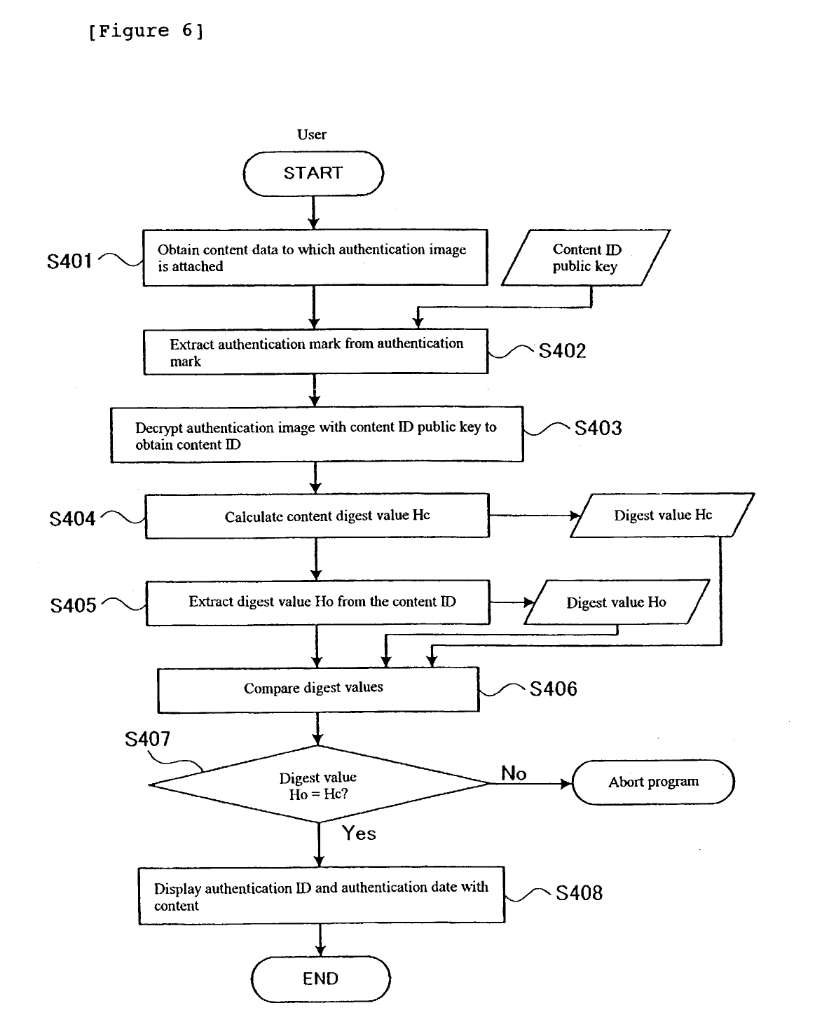

FIG. 6 is a process flow chart illustrating the manner in which a user displays authenticated data on the user's terminal 50B. The communication module 51 in the user's terminal 50B receives (obtains) the content data (D) over the network 20 and temporarily stores it in memory, not shown (step S401).

When the content browser is activated, the processing module 55 performs the following process.

The data decryptor 56 extracts the authentication mark (Ke) data embedded as digital watermark from the authentication image data attached to the content data (D) (step S402).

If the digital watermark cannot be extracted from the authentication image, the authentication image is deemed to be invalid and the content is not allowed to be displayed.

Extracted authentication mark (Ke) data extracted is decrypted by using the content ID public key (KpubA) included in the content browser together with computation expression V to obtain the content ID (Did) (step S403):

Did=V_{KpubA} (Ke).

The content ID public key (KpubA) is invalid if it does not correspond to the content ID private key (KpriA) that is the encrypted authentication mark (Ke). Consequently, the authentication mark (Ke) data cannot be decrypted, the remaining part of the process cannot be performed, the content cannot be displayed, and the process may be ended with displaying a message Indicating that the content cannot be displayed.

The user may confirm that the rater ID (Aid) and the authentication date included in the content ID are valid by communicating with the content rater's terminal 30B through the network 20. If they are valid, the process continues with the subsequent steps. On the other hand, if it cannot be determined that they are valid, the process is aborted and the content is not displayed.

The content examination module 57 calculates the digest value Hc of the content data (D) (step S404), extracts the digest value Ho contained in the content ID (Did) (step S405), and compares the digest values Ho and Hc (steps S406 to S407).

If the digest value Hc calculated is equal to the digest value Ho contained in the content ID (Did), the content display controller 58 displays the content on the display module 53 based on the content data (D). The rater ID (Aid) and authentication date contained in the content ID (Did) may be displayed along with the content (step S408).

On the other hand, if in step S402 the digest value Hc calculated is not equal to the digest value Ho contained in the content ID (Did), the content received on the user's terminal 50B may be different from the content rated at the content rater. That is, it may have been modified or altered by an unauthorized third party. Consequently, the content display controller 58 terminates the browser without displaying the content.

According to the arrangement described above, the user's terminal 50B can display contents authenticated by content rater. Moreover, it is determined whether contents have been altered by an unauthorized third party and only the contents that have not been adulterated are displayed. Thus, users can obtain valid contents with security.

In addition, because the authentication mark (Ke) containing the content ID is embedded in the authentication image as the digital watermark, tampering of the content ID by a third party can be prevented.

Furthermore, the content creator can restrict viewing of or listening to its contents and therefore present contents only to the users who have registered themselves with the content creator. The content creator can thus collect viewing or listening fees without omission.

The authentication image with digital watermark described with respect to this embodiment may be attached to one content by more than one content rater. This makes it possible to persuade users that the content is of a higher degree of safety by indicating that the content has been approved by a number of content rater.

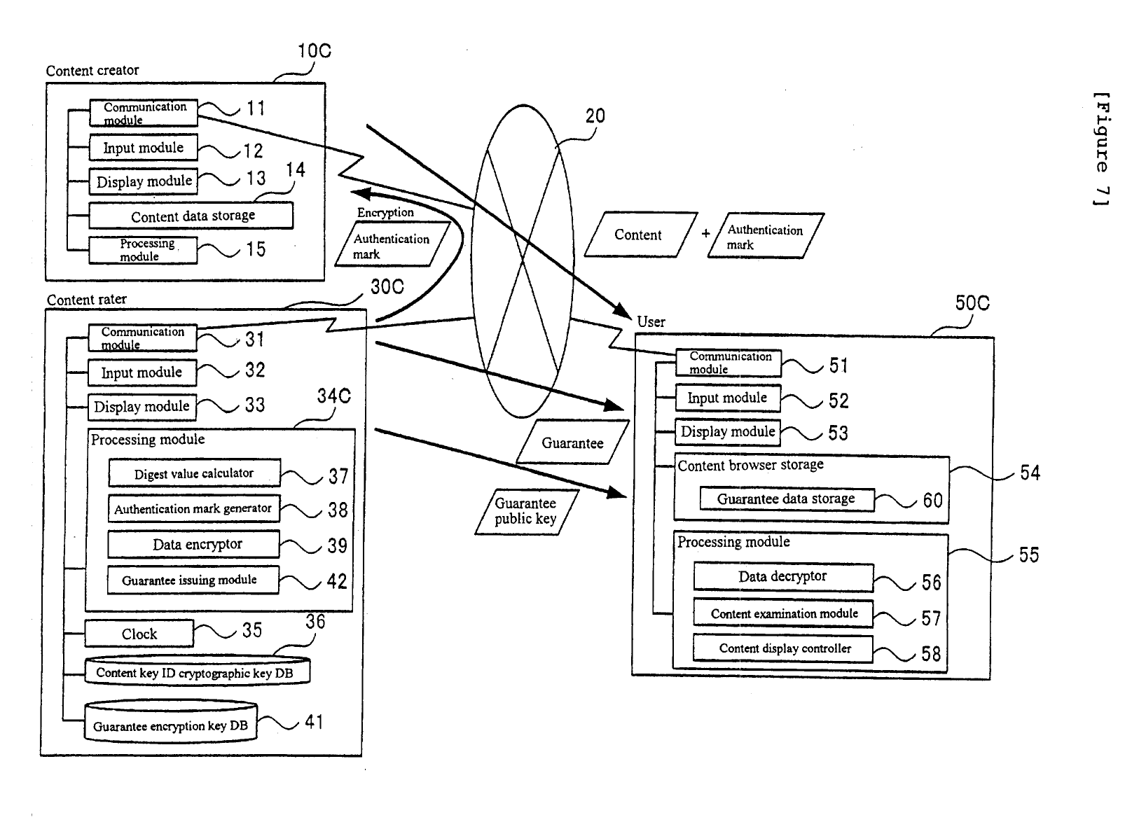

Yet another embodiment of the present invention, as shown in FIG. 7, will be described below. This embodiment primarily differs from the previous embodiments in that it uses a guarantee instead of an authentication mark or a digital watermark. The same components in this embodiment will be labeled with the same reference numbers as before and the description of these components will be omitted.

FIG. 7 illustrates a general configuration of a content display restriction system.

As shown in FIG. 7, a content creator presents a created content on a network 20 such as the Internet through a terminal 10C of the content creator. The content creator receives authentication mark data indicating that a content is authenticated by a content rater from a terminal 30C of the content rater over the network 20. When the content creator's terminal 10C is accessed by a terminal 50C of a user, it sends content data to which the authentication data is attached to the user's terminal 50C.

A content rater's terminal 30C, on the other hand, generates a guarantee and sends it to the user's terminal 50C. The guarantees are available in a number of categories, such as “no one under 15 allowed to view or listen” and “no one under 18 allowed to view or listen” as appropriate. The user receives from the rater a guarantee of a category he or she chooses.

In the user's terminal 50C, the content is verified based on information contained the authentication mark embedded in the content received and outputs the content only if it corresponds to the category of the guarantee that the user has received.

The content creator's terminal 10C comprises a communication module 11, an input module 12, a display module 13, a content data storage 14, and a processing module 15.

The content raters terminal comprises a communication module 31, an input module 32, a display module 33, a processing module 34C, a clock 35, a content key ID cryptographic key database 36, and a guarantee encryption key database (key information storage) 41 for storing private and public key data used to encrypt and decrypt a guarantee.

The processing module 34C comprises a guarantee issuing module (control information generator) 42 for issuing a guarantee to users in addition to a digest value calculator 37, an authentication mark generator 38, and a data encryptor 39.

The user's terminal 50C comprises a communication module 51, an input module 52, a display module 53, a content browser storage 53, and a processing module 55. In addition, it comprises a guarantee data storage 60 for storing data on guarantee issued from the content rater's terminal 30C.

The processing module 55 comprises a data decryptor 56, a content examination module 57, and a content display controller 58.

To display content in a content display restriction system as described above, a content rater searches through contents presented on the network 20 on the content rater's terminal 30C. If a content is found that meets predetermined criteria set by the content rater, the content rater starts a process for assigning an authentication mark to that content.

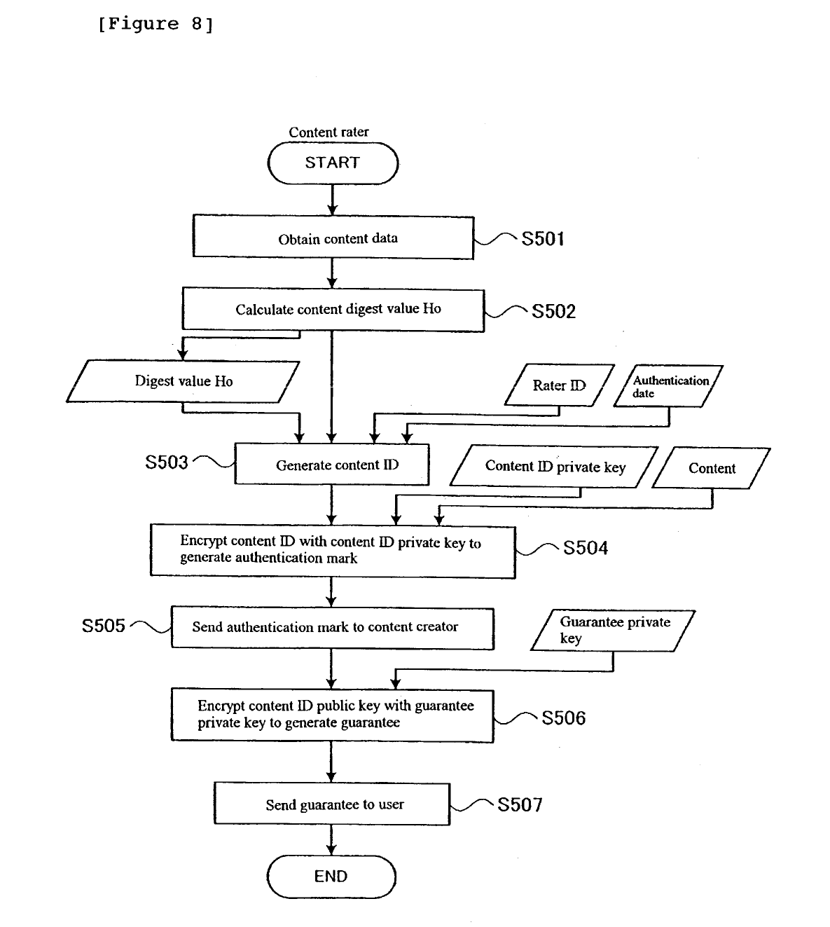

FIG. 8 illustrates a method of operation of the content display restriction system of FIG. 7. As shown in FIG. 8, content data (D) found is obtained through the communication module 31 and stored in memory, not shown, in the content rater's terminal 30C (step S501).

The digest value calculator 37 in the processing module 34C calculates the digest value (Ho) of the content data (D) obtained (step S502):

Ho=hash (D),

where hash is a computation expression for calculating the digest value.

The authentication mark generator 38 in the processing module 34C uses information including the digest value (Ho), an rater ID (Aid) of the rater that has rated the content, and the authentication date on which the content has been authenticated to generate a content ID (Did) (step S503).

The content ID (Did) generated is encrypted by the data encryptor 39 in the processing module 34C by using a content ID private key (KpriA) and calculation expression S to generate an authentication mark (Ke) (step S504):

Ke=S_{KpriA} (Did).

The content rater's terminal 30C sends the authentication mark (Ke) data through the communication module 31 to the context creator's terminal 10C over the network 20 (step S505).

While sending the authentication mark (Ke) data to the content creator's terminal 10C, the guarantee issuing module 42 in the content rater's terminal 30C generates a guarantee (G). The guarantee (G) is encrypted in the data encryptor 39 by retrieving from the content key ID cryptographic key database 36 a content ID public key (KpubA) paired with the content ID private key (KpriA) used for encrypting the content ID (Did). The encryption is accomplished by using a guarantee private key (KpriB) retrieved from the guarantee encryption key database 41 and a calculation expression S (step S506):

G=S_{KpriB} (KpubA).

The generated guarantee (G) data is sent from the communication module 31 to a user's terminal 50C in response to a request for issuance of a guarantee provided by the user (step S507). The guarantee (G) may be provided to the user for free or for a fee that is included in a content viewing fee. The guarantee (G) may by issued for each content or may be issued to a registered user on a membership basis and made effective for a number of contents.

The authentication mark (Ke) data sent at step S505 is received by the communication module 11 in the content creator's terminal 10C over the network 20. Authentication image data is attached to the content data (D) automatically or by a predetermined operation performed by the content creator and the content data (D) with the authentication image data is stored in the content data storage 14.

After the content is authenticated by the content rater, the content creator presents the content (hereinafter called the “authenticated content”) on the network 20.

The user must install a content browser program and store that browser program in the content browser storage 54 in the user's terminal 50C beforehand to display the authenticated content. The content browser program contains a guarantee public key (KpubB) for decrypting the guarantee (G) data described above.

The guarantee (G) data sent from the content rater's terminal 30C at step S507 is received by the communication module 51 in the user's terminal 50C over the network 20 and stored in the guarantee data storage 60 automatically or by a predetermined operation performed by the user.

The user then access the authenticated content presented on the network 20 via the user's terminal 50C.

When accessed by the user's terminal 50C over the network 20, the content creator's terminal 10C sends via the communication module 11 the authenticated content, that is, the content data (D) to which authentication image data is attached, stored in the content storage 14.

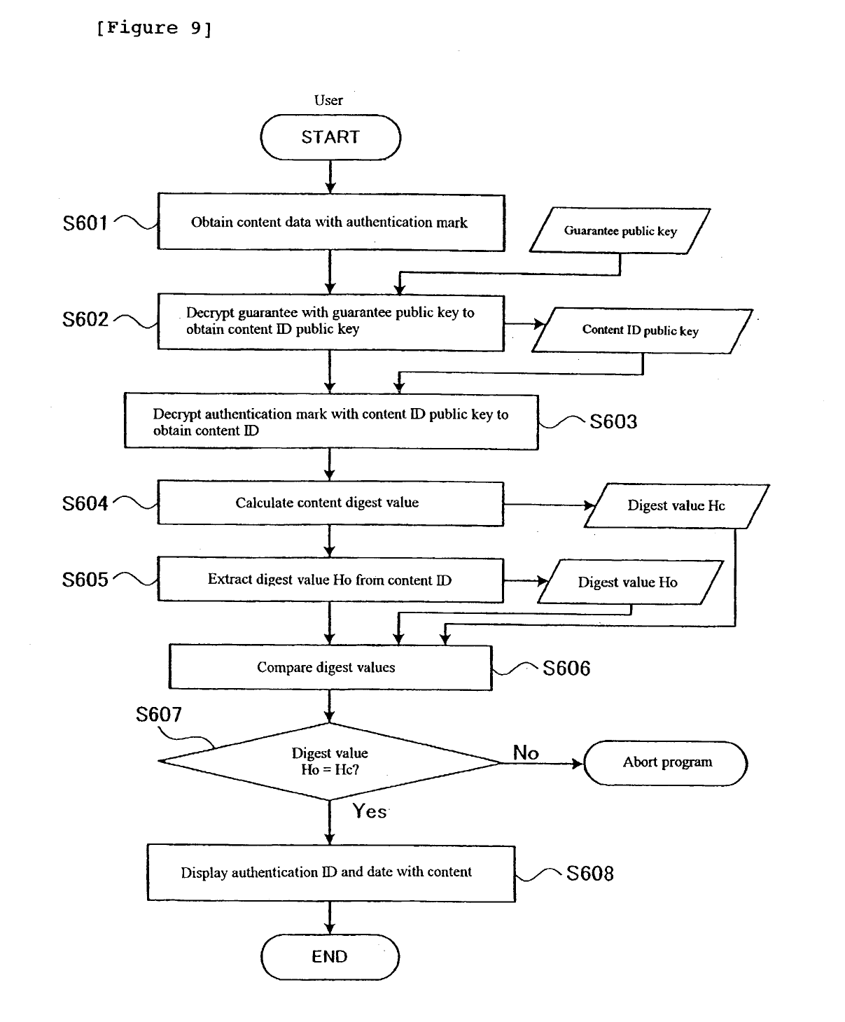

FIG. 9 is a process flow chart illustrating the manner in which a user displays authenticated data on the user's terminal 50C. As shown in FIG. 9, the communication module 51 in the user's terminal 50C receives (obtains) the content data (D) with the authentication image data over the network 20 and temporarily stores it in memory, not shown (step S601).

When the content browser is activated, the processing module 55 performs the following process.

The guarantee (G) data is decrypted by using the guarantee public key (KpubB) included in the content browser and a computation expression V to obtain content ID public key (KpubA) (step S602):

KpubA=V_{KpubB} (G).

The data decryptor 56 uses the content ID public key (KpubA) obtained at step S602 and a computation expression V that decrypts the authentication mark (Ke) data attached to the content data (D) to obtain the content ID (Did) (step S603):

Did=V_{KPubA} (Ke).

If the category of the guarantee (G) held by the user is not valid, that is, if the content ID public key (KpubA) does not correspond to the encrypted content ID private key (KpriA), the authentication mark (Ke) data cannot be decrypted. Consequently, the remaining part of the process cannot be performed. If this is the case, the process may be terminated with displaying a message indicating that the content cannot be displayed.

The user may confirm that the rater ID (Aid) and the authentication date included in the content ID are valid by communicating with the content rater's terminal 30C through the network 20. If they are valid, the process continues with the subsequent steps. On the other hand, if it cannot be determined that they are valid, the process is aborted and the content is not displayed.

The content examination module 57 calculates the digest value Hc of the content data (D) (step S604), extracts the digest value Ho contained in the content ID (Did) (step S605), and compares the digest values Ho and Hc (step S606).

If at step S607 the digest value Hc calculated is equal to the digest value Ho contained in the content ID (Did), the content display controller 58 displays the content on the display module 53 based on the content data (D). The rater ID (Aid) and authentication date contained in the content ID (Did) may be displayed along with the content (step S608).

On the other hand, if in step S607 the digest value Hc calculated is not equal to the digest value Ho contained in the content ID (Did), the content received at the user's terminal 50C may be different from the content rated at the content rater. That is, it may have been altered by an unauthorized third party. Consequently, the content display controller 58 terminates the browser without displaying the content.

According to the arrangement described above, the user's terminal 50C can display contents authenticated by content rater. In addition, it is determined whether contents have been altered by an unauthorized third party and only the contents that have not been adulterated are displayed. Thus, users can obtain valid contents with security. Furthermore, the content creator can restrict viewing of or listening to its contents and therefore present contents only to the users who have registered themselves with the content creator. The content creator can thus collect viewing or listening fees without omission.

In addition, the authentication mark (Ke) including the content ID is attached by the content creator's terminal 10C to the content to be presented. In addition, the guarantee is sent to the user's terminal 50C from the content rater's terminal 30C. The authentication mark (Ke) attached to the content cannot be decrypted without the guarantee, therefore, a third party is prevented from opening the content.

Furthermore, because the user can specify the category of a guarantee to be issued from the content rater, he or she can place restrictions on content viewing according to his or her discretion.

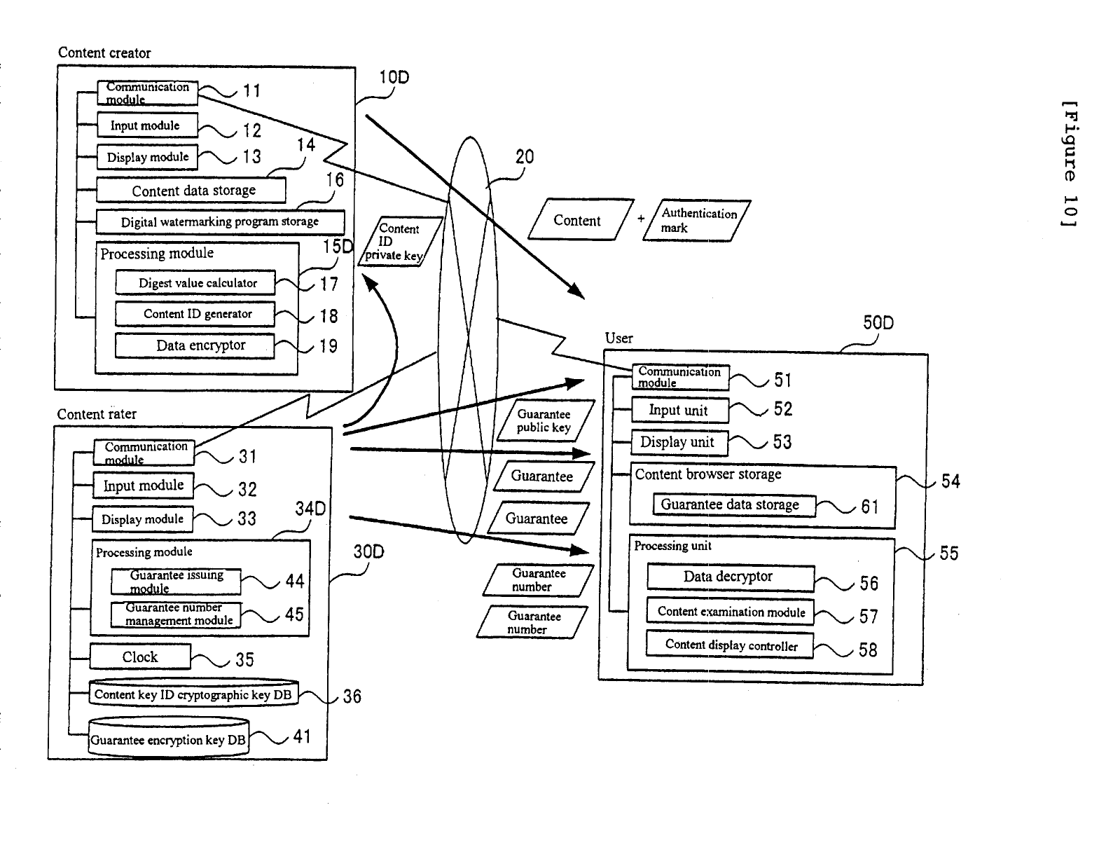

Yet another embodiment of the present invention, as shown in FIG. 10, will be described below. While the digest value of a content is calculated and a content ID is issued by a content rater's terminal in the previous embodiments, these operations are performed by a content creator in this embodiment. In addition, a configuration in which a guarantee is updated as required will be described. The same components in this embodiment will be labeled with the same reference numbers as before and the description of these components will be omitted

FIG. 10 illustrates a general configuration of a content display restriction system.

As shown in FIG. 10, a content creator creates a content at the request of a content rater. The content creator calculates the digest value of the content on a terminal 10D of the content creator to create the content ID of the content, attaches it to the content, and presents it on a network 20 such as the Internet. When accessed by a terminal 50D of a user, the content creator's terminal 10 sends the content data to the user's terminal 50D.

A terminal 30D of the content rater generates a guarantee and sends it to the user's terminal 50D. Guarantees may be available in a number of categories such as “no one under 12 allowed to view or listen,” “no one under 15 allowed to view or listen,” and “no one under 18 allowed to view or listen,” as required. The user receives from the rater a guarantee of a category he or she chooses. The guarantee number of each guarantee is encrypted and the guarantee number is updated on the content rater's terminal, as required. Each time the guarantee number is updated, the content rater indicates the most up-to-date guarantee number to the user.

The user's terminal 50D verifies the content based on information contained in an authentication mark embedded in the received content and outputs the content only if it corresponds to the category of the guarantee that the user has received.

The content creator's terminal 10D comprises a communication module 11, an input module 12, a display module 13, a content data storage 14, and a processing module 15D. The content creator's terminal 10D in the fourth embodiment further comprises a digital watermarking program storage 16 for storing a digital watermarking program.

The processing module 15D comprises a digest value calculator 17 for calculating the digest value of a content, a content ID generator (control information generator) 18 for generating a content ID to be attached to the content, and a data encryptor 19 for encrypting data to be sent through the communication module 11.

The content rater's terminal 30D comprises a communication module 31, an input module 32, a display module 33, a processing module 34D, a clock 35, a content key ID cryptographic key database 36, and a guarantee encryption key database 41 for storing private and public keys used to encrypt and decrypt a guarantee to be issued.

The processing module 34D comprises a guarantee issuing module (control information generator) 44 for issuing a guarantee to a user and a guarantee number management module 45 for managing the guarantee number of the guarantee issued.

The user's terminal 50D comprises a communication module 51, an input module 52, a display module 53, a content browser storage 54, and a processing module 55. It further comprises a guarantee data storage 61 for storing guarantee and guarantee number data provided from the content rater's terminal 30D.

The processing module 55 comprises a data decryptor 56, a content examination module 57, and a content display controller 58.

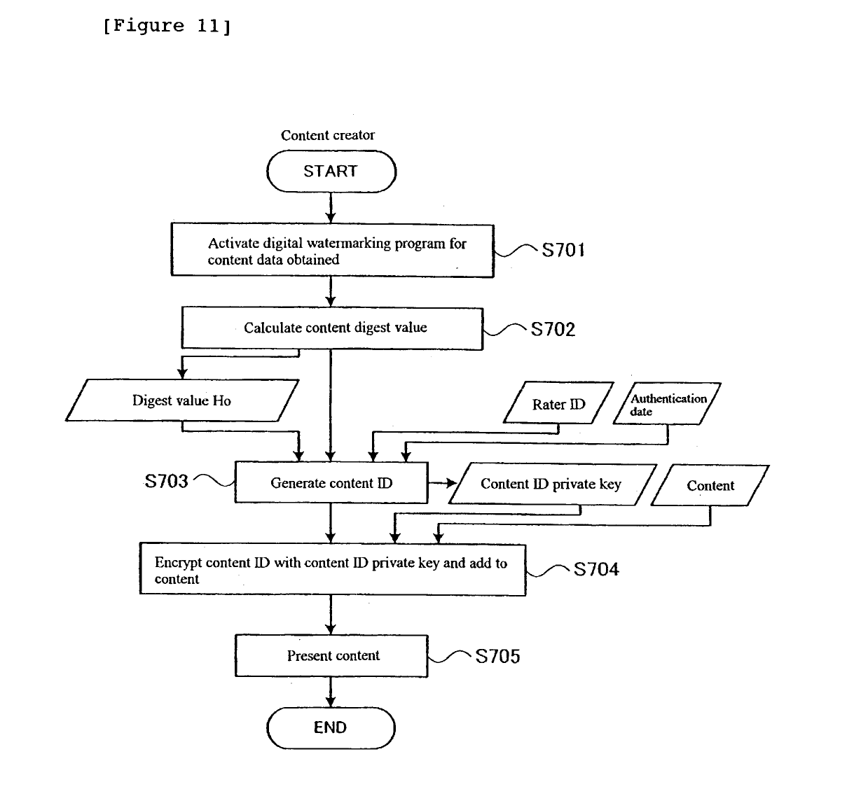

FIG. 11 is a process flow chart illustrating a method for displaying a content in a content display restriction system as described above.

The content rater requests the content creator to create a content. In such a case, the content creator is trustworthy to the content rater and the content rater also requests the content creator to create the content ID of the content. For this purpose, the content rater sends a digital watermarking program for adding a predetermined digital watermark to the content to the content creator. The content creator stores the sent digital watermarking program in the digital watermarking program storage 16 in the content creator's terminal 10D.

The request for creating the content sending the digital watermarking program may be performed over the network 20 or offline.

After receiving the request from the content rater and creating the content, the content creator activates the digital watermarking program for the created content on the content creator's terminal 10D (step S701) as shown in FIG. 11.

The digest calculator 17 in the processing module 15D calculates the digest value (Ho) of the content data (D) generated (step S702):

Ho=hash (D),

where hash is a computation expression for calculating the digest value.

The content ID generator 18 in the processing module 15D generate a content ID (Did) (step S703) using information including the digest value (Ho), the rater ID (Aid) of the rater that has rated the content generates a content ID (Did), and the authentication data on which the authentication date (and possibly time) on which the content is authenticated..

The content ID (Did) is encrypted by the data encryptor 19 in the processing module 15D by using a content ID private key (KpriA) and a computation expression S to generate an authentication mark (Ke):

Ke=S_{KpriA} (Did).

The authentication mark (Ke) is added to (embedded in) the content data as a digital watermark to generate content (D′) data with authentication (step S704):

D′=WM (Ke, d),

where WM is a computation expression for embedding the digital watermark.

A number of content ID private keys (KpriA) used for encryption are made available and the content rater or creator selects one of them according to the type of the content. That is, the content rater or creator rates a content as “no one under 12 allowed to view or listen,” “no one under 15 allowed to view or listen,” “no one under 18 allowed to view or listen,” or “no restrictions on viewing or listening.” A content ID (Did) is encrypted by using a content ID private key (KpriA) corresponding to the rating.

The content creator terminal 10D presents the authenticated content data (D′) with the digital watermark on the network 20 (step S705).

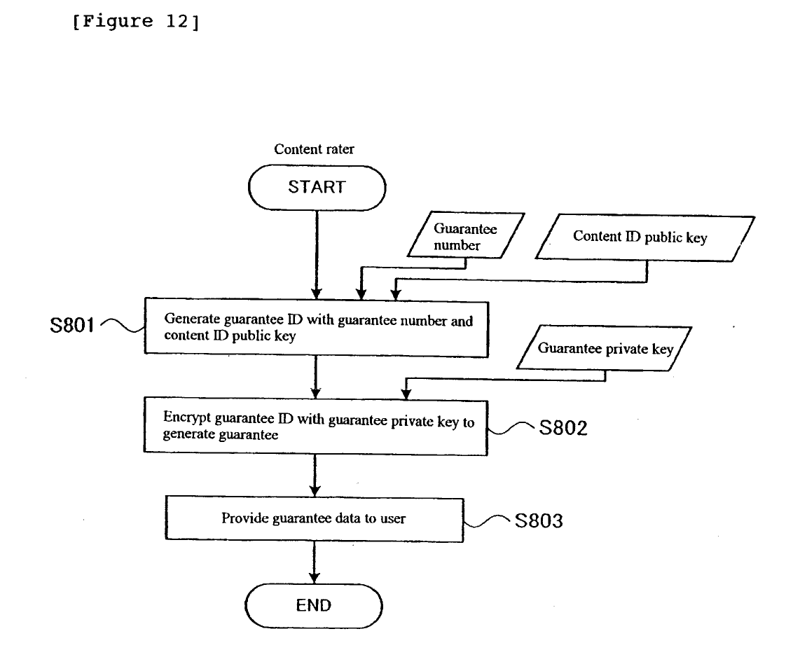

FIG. 12 is a process flow chart illustrating a method by which a guarantee (G) is generated in the content rater's terminal 30D and provided to the user. The guarantee issuing module 44 generates a guarantee ID (Gid) that contains a currently valid guarantee number of the guarantee (G) to be generated and a content ID public key (KpubA) corresponding to the content ID private key (KpriA) used for encrypting the content ID (Did) (step S801):

Gid=E (guarantee number, KpubA).

Then the guarantee ID (Gid) is encrypted to produce the guarantee (G). The encryption is performed by using a guarantee private key (KpriB) retrieved from the guarantee encryption key database 41 and a calculation expression S (step S802):

G=S_{KpriB} (Gid).

A number of categories of guarantees (G) may be made available by the content rater. In that case, each category of guarantee would contain a guarantee number and content ID public key (KpubA) associated with that category. For example, if the content rater makes available three guarantee categories, “no one under 12 allowed to view or listen,” “no one under 15 allowed to view or listen,” and “no one under 18 allowed to view or listen,” different guarantee numbers and different content ID public keys (KpubA) are contained in guarantees of the three different categories.

The guarantee (G) data generated is sent through the communication module 31 to the user's terminal 50D in response to a request from the user (step S803).

The guarantee (G) is issued for free or pay and contains a guarantee number and public key associated with the category requested by the user.

The user must install and store a content browser in the content browser storage 54 in the user's terminal 50D beforehand for displaying authorized contents. A guarantee public key (KpubB) for decrypting the guarantee (G) data is contained in a predetermined data area in a file containing the content browser program. When the content browser is installed in the user's terminal 50D, the guarantee public key (KpubB) is stored in a predetermined data storage such as an HDD.

When the guarantee (G) data transmitted over the network 20 from the content rater's terminal 30D (step S803) is received at the communication module 51 in the user's terminal 50D, the guarantee (G) data is stored in the guarantee data storage 61 automatically or by a predetermined operation performed by the user.

In the content rater's terminal 30D, the guarantee number management module 45 updates the guarantee number of each guarantee (G) periodically, for example monthly, or at an appropriate time, such as when the content or guarantee is changed. The most up-to-date number (list) is periodically sent to the user's terminal 50D. The sent guarantee number is stored in the guarantee data storage 61 in the user's terminal 50D. This allows the user's terminal 50D to hold the guarantee number that is currently effective.

The user uses the user's terminal 50D to access the authenticated content presented on the network 20.

When accessed by the user's terminal 50D over the network 20, the content creator's terminal 10D sends through the communication module 11 the authenticated content (D′) data to which authentication image data is attached and which is stored in the content data storage 14.

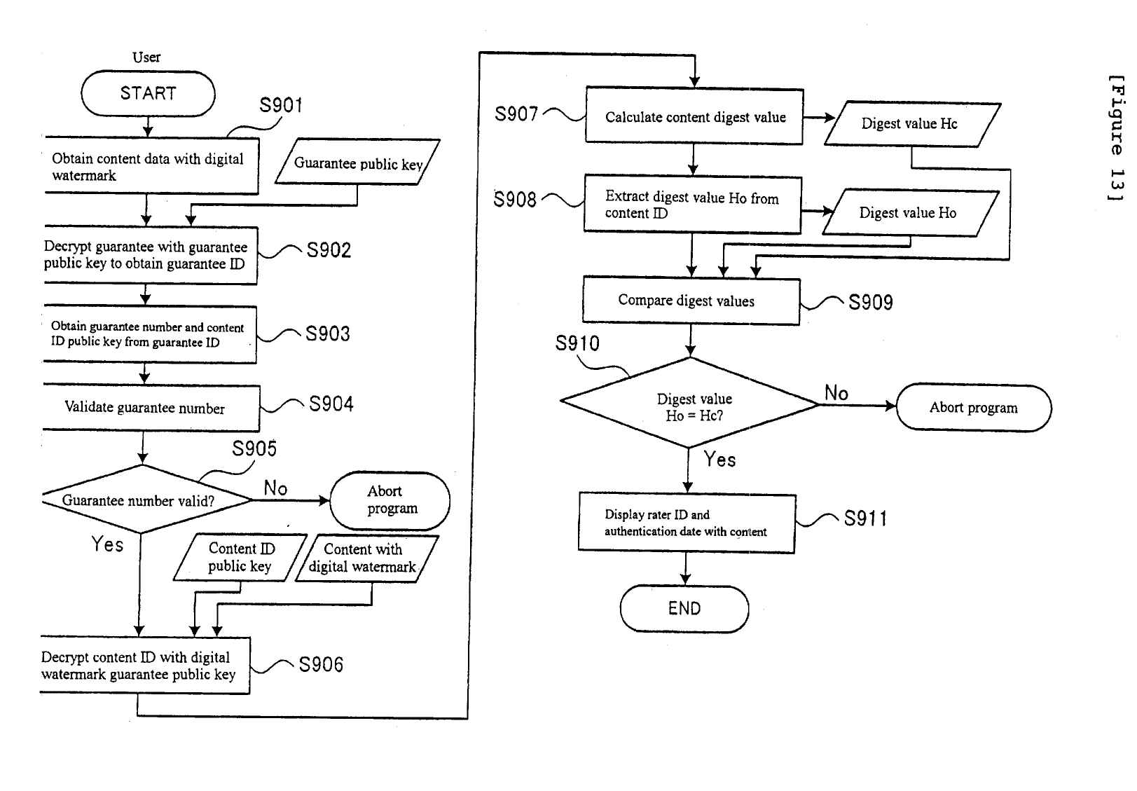

As shown in FIG. 13, the communication module 51 in the user's terminal 50D receives (obtains) the authenticated content data (D′) over the network 20 and temporarily stores it in memory, not shown (step S901).

When the content browser is activated, the processing unit 55 performs the following process.

The guarantee (G) data is decrypted by using the guarantee public key (KpubB) included in the content browser and a computation expression V to obtain the guarantee ID (Gid) (step S902):

Gid=V_{KpubB} (G).

The processing unit 55 then obtains the guarantee number and content ID public key (KpubA) from the guarantee ID (Gid) (step S903).

The processing unit 55 queries the content rater's terminal 30D over the network 20, for example, to determine whether the guarantee number is valid (step S904). If it is determined at step 905 that the guarantee number is invalid, the content browser terminates.

On the other hand, if it is determined at step 905 that the guarantee number is valid, the data decryptor 56 extracts from the authenticated content (D′) data the authentication mark (Ke) embedded in it as a digital watermark:

Ke=WM⁻¹ (D′),

where WM⁻¹ is a computation expression for extracting a digital watermark.

If the digital watermark is not extracted from the authentication image, the authentication image is invalid. Consequently, the remaining part of the process cannot be performed and the content cannot be displayed.

After the digital watermark is extracted, the content ID public key (KpubA) obtained from the authentication mark (Ke) at step 903 is used with a computational expression V to decrypt the encrypted content ID to obtain the content ID (Did) (step S906):

Did=V_{KpubA} (Ke).

If the content public key (KpubA) is invalid, that is, if it does not correspond to the encrypted content ID private key (KpriA), the content ID (Did) cannot be decrypted and the remaining part of the process cannot be performed. If this is the case, the process may be terminated with displaying a message indicating that the content cannot be displayed.

If the category of the guarantee held by the user corresponds to the rating of the content, the authenticated content (D′) can be decrypted by using the content ID public key (KpubA) held by the user together with the guarantee. For example, if the use hold holds a guarantee of a category, “no one under 12 allowed to view or listen” and the content is rated as “no restrictions,” the authenticated content (D′) can be decrypted by using the content ID public key (KpubA). On the other hand, if the user holds a guarantee of a category, “no one under 12 allowed to view or listen” and the content is rated as “no one under 15 allowed to view or listen,” the authenticated content (D′) cannot be decrypted with the content ID public key (KpubA). Consequently, the remaining part of the process cannot be performed and the content cannot be reproduced.

The user may confirm that the rater ID (Aid) and the authentication date included in the content ID are valid by communicating with the content rater's terminal 30D through the network 20 If so, the process continues with the subsequent steps. On the other hand, if it cannot be determined that they are valid, the process is aborted and the content is not displayed.

The content examination module 57 calculates the digest value Hc of the content data (D) contained in the decrypted authenticated content data (D′) (step S907), extracts the digest value Ho contained in the content ID (Did) (step S908), and compares the digest values Ho and Hc (step S909).

If the digest value Hc calculated is equal to the digest value Ho contained in the content ID (Did) (step S910), the content display controller 58 displays the content on the display module 53 based on the content data (D) (step S911). The rater ID (Aid) and authentication date contained in the content ID (Did) may be displayed along with the content.

On the other hand, if the digest value Hc calculated is not equal to the digest value Ho contained in the content ID (Did), the content received at the user's terminal 50D may be different from the content rated at the content rater. That is, it may have been altered by an unauthorized third party. Therefore, the content display controller 58 terminates the browser without displaying the content.

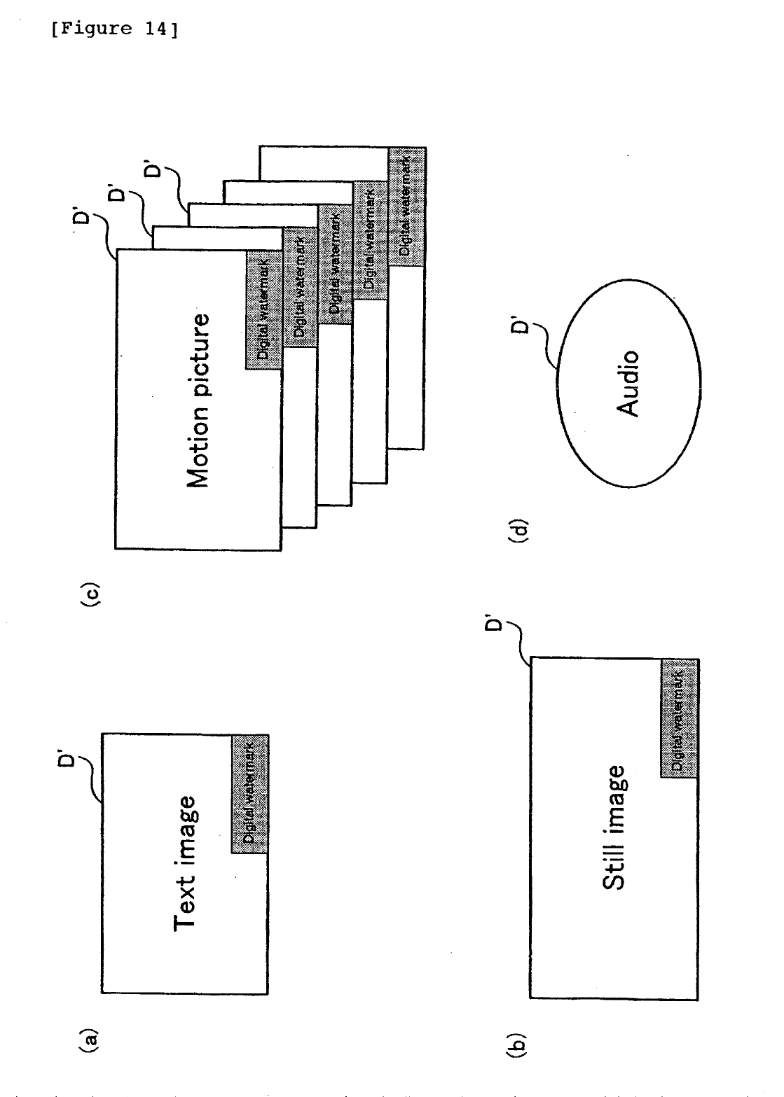

FIG. 14 (FIGS. 14A, 14B, 14C, 14D) shows an example of the authenticated content (D′) provided to the user according to the method as described above. If the authenticated content (D′) is a text image such as a PDF format text, or a still image, a digital watermark is inserted in a part of the content (D′) as shown in FIGS. 14A and 14B.

the authenticated content (D′) is a motion picture, a digital water mark is inserted in a part of each frame f image (content D′) of the motion picture, as shown in FIG. 14C. If the content is audio data, the audio data continuing along the time axis is divided into given time units and a digital watermark is inserted in each time unit.

According to the arrangement described above, contents authenticated by a content rater can be displayed on the user's terminal 50D. Moreover, it is determined whether contents have been altered by an unauthorized third party or not and only the contents that have not been tampered are displayed. Thus, users can obtain valid contents with security.

In addition, a content ID is added to a content to be published on the content creator's terminal 10D and a guarantee is sent to the user's terminal 50D from the content rater's terminal 30D. Because the content ID cannot be decrypted from the digital watermark inserted in the content without a valid guarantee, a third party other than the user is prevented from opening the content. Thus, the content creator can present their contents only to users who have registered themselves with the content creator. Consequently, content creators can collect viewing or listening fees without omission.

Because user can specify the category of the guarantee to be issued from the content rater, the user can place restrictions on content viewing according to his or her discretion.

The content rater periodically indicates the up-to-date guarantee number to the user. The user compares it with the guarantee number included in a content ID sent to the user's terminal 50D along with a content ID. Unless the user has the up-to-date guarantee number, he or she cannot display the content. This arrangement allows the content rater to charge a fee to the user on a regular basis, for example on a month-by-month basis. If the user does not properly pay the fee, he or she cannot receive the up-to-date guarantee number and therefore cannot display the content. That is, the arrangement as described above can ensure billing for contents.

The above-described arrangement can also apply to uses, besides viewing restrictions based on ages as in the example described above in which categories “no one under 12 allowed to view or listen,” “no one under 15 allowed to view or listen,” “no one under 18 allowed to view or listen,” an “no restrictions” are provided. The arrangement can also be applied to services, such as cable television services that provide contents through a number of channels. Suppose that a cable television company provides 30 channels. It may grade its services as the bronze grade in which 10 channels are made available to viewers, the silver grade in which 20 channels are made available, and the gold grade in which all of the 30 channels are made available, according to viewing fees. A content rater may issue guarantee numbers and guarantee public keys according to the grades. Contents are categorized as “available to gold-grade viewers only,”,“available to gold-grade and silver-grade viewers only,” and “available to all viewers” and each content ID is encrypted by using a content ID private keys (KpriA) associated with each grade. A user receives a guarantee public key and guarantee number for a grade for which he or she is registered and uses them to decrypt the ID of a content to reproduce the content.

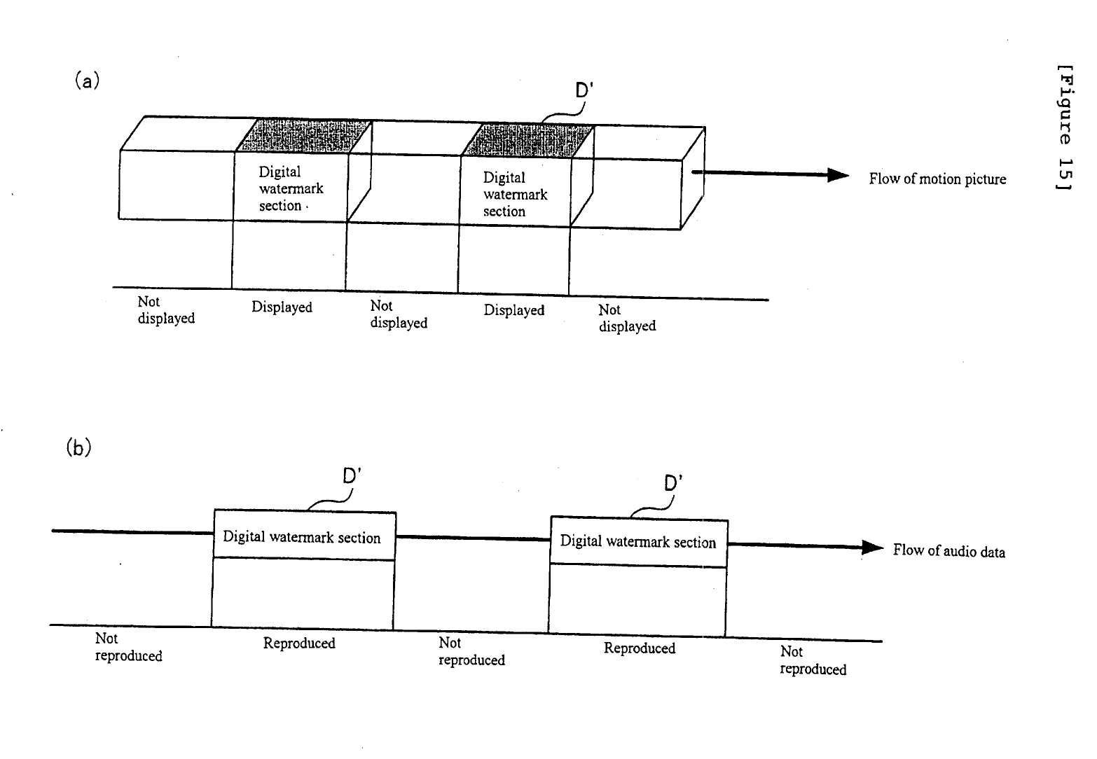

FIG. 15 (FIGS. 15A, 15B)shows an example of the reproduction or motion picture and audio contents to which the above-described arrangement is applied.

If motion picture or audio data delivered from a content creator's terminal 10D as a authenticated content (D′) contains, in a alternating sequence, sections in which a guarantee that is valid for a user is inserted and sections in which a digital watermark for which the user does not have a valid guarantee number is inserted, as shown in FIGS. 15A and 15B, the user's terminal 50D displays or reproduces only sections containing the digital watermark for which the user has the valid guarantee. The other sections are not displayed or reproduced.

In this way, a guarantee can be provided for each movie or each title of music so that a user can only display a movie or listen to music for which he or she has a valid guarantee. In addition, different guarantees may be provided for one movie or title of music and a content rater may issue a guarantee number to an authorized user (a subscriber paying a subscription fee) so that he or she can display or reproduce the entire move or title of music and issue a guarantee for only portions of the movie or music to the other users (non-subscribers) so that it is displayed or reproduced intermittently, like a scrambled broadcast.

In another embodiment, a user can obtain a plurality of guarantees and guarantee numbers. The embodiment may be configured in such a manner that the user can specify and use one or more of the plurality of guarantees that he or she holds.

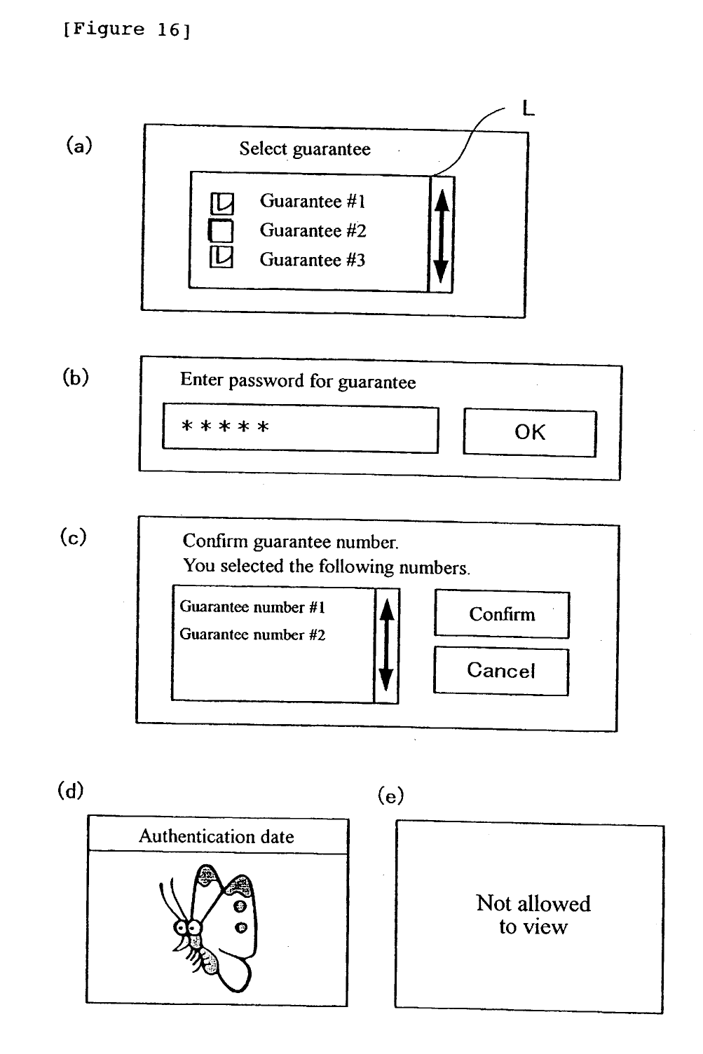

For example, a user may obtain guarantees #1 through #3 from the content rater's terminal 30D and store them in the guarantee data storage 61 in the user's terminal 50D. At an appropriate time before displaying contents, the user may display a list L of the guarantees #1 through #3 to the display 53, as shown in FIG. 16A. When the user selects particular guarantees (guarantees #1 and #3) from the list L, only the contents corresponding to the guarantees #1 and #3 may be displayed.

The user may be prompted to input a valid password (guarantee public key (KpubB), for example) for each of selected guarantees #1 and #3 as shown in FIG. 16B, in case an unauthorized user such as a child operates the user's terminal 50D to select guarantees from the list L. If the password entered is valid, the corresponding password can be selected.

If the password is valid, steps S901 through S905 in FIG. 13 are performed. The categories of the guarantee obtained at step S903 are presented to the user for confirmation, as shown in FIG. 16C. If the user performs a confirmation operation, step S906 and the subsequent steps in FIG. 13 are performed and the display of the content (D) can be enabled as shown in FIG. 16D or the display of content (D) can be disabled as shown in FIG. 16E.

Selection of guarantees to be made effective, shown in FIG. 16A, may be made beforehand by associating them a login ID or login password used during activation of a PC or browser so that content display restrictions are automatically changed according to the login ID, that is, a user of the user's terminal 50D.

In the embodiments, content browser programs and guarantees to be provided to users from the content raters and creators may be stored in a removable storage medium such as a CD-ROM and floppy disk and delivered to the users by mail or other means, rather than transmitting over a network 20 to the user's terminals 50A, 50B, 50C, and 50D. The user loads data stored in the storage medium into the user's terminal 50A, 50B, 50C, and 50D to install the content browser or guarantee data. Furthermore, the guarantee numbers describe with respect to the fourth embodiment may be provided by e-mail.

The embodiments have been described in which content data (D) is directory provided from the content creator's terminal 10A, 10B, 10C, and 10D to the user's terminal 50A, 50B, 50C, and 50D over the network 20. However, if a content creator (especially a company) presents contents created on the content creator's terminal on the network 20 through an ISP (Internet Service Provider) server or their own server, the content data (D) may be delivered from that server to the user's terminal 50A, 50B, 50C, and 50D. That is, the server functions as the content creator's terminal 10A.

While the first three embodiments have been described in which a digest value is calculated at a content rater to rate a content, the calculation may be performed at the content creator as in the fourth embodiment. In addition, in the fourth embodiment in which guarantee numbers are used, a digest value may be calculated at a content rater to rate a content as in the first through third embodiments.

The embodiments have been described in which public keys for encrypting and decrypting content IDs or other data has in effect the function of restricting content viewing. However, instead of the public keys, passwords or secret identification codes having the function of restricting content viewing may be issued by a content rater to a user as key information.

While the fourth embodiment has been described in which the categories of guarantees are identified by different guarantee public keys, the categories of guarantees may be identified by comparing information in the user's terminal 50D with information contained in content IDs associated with contents for identifying the categories of the guarantees.

A program for causing a computer to perform the processes described with respect to the embodiments can be stored in a recording medium, such as a CD-ROM, DVD, memory, or hard disk, or like devices in computer-readable form.

It is to be understood that the specific embodiments of the invention that have been described are merely illustrative of certain application of the principle of the present invention. Numerous modifications may be made to the method for providing and reproducing content invention described herein without departing from the spirit and scope of the present invention.

What is claimed is:

1. A method for providing a content that comprises control information and data from a content provider to a user terminal, the method comprising:
calculating a first digest value of the content by the content provider;
calculating a second digest value of the content on the user terminal;
generating the control information that comprises the first digest value, for controlling a reproduction of the content, by comparing the first digest value with the second digest value;
outputting the control information and the data, to the user terminal; and outputting key information to further control the reproduction of the content, by determining whether the control information is valid.

2. The method of claim 1, wherein the content provider comprises a first content provider that generates the content, and a second content provider that is different from the first content provider and that rates the content.

3. The method of claim 2, wherein generating the control information comprises the second content provider encrypting the control information, and outputting the encrypted control information to the first content provider.

4. The method of claim 3, wherein outputting the control information and the data comprises the first content provider combining the encrypted control information with the data.

5. The method of claim 4, wherein the key information comprises decryption key data that is used to decrypt the encrypted control information.

6. The method of claim 5, further comprising disallowing the first content provider from altering the control information.

7. The method of claim 6, further comprising allowing only a user with access to both the encrypted control information and the decryption key data to decrypt the encrypted control information.

8. The method of claim 1, further comprising reproducing the content if the first digest value and the second digest value are identical and the control information is determined to be valid based on the key information.

9. A computer program product having instruction codes for providing a content that comprises control information and data from a content provider to a user terminal, the computer program product comprising:
a first set of instruction codes for calculating a first digest value of the content by the content provider, and for further calculating a second digest value of the content on the user terminal;
a second set of instruction codes for generating the control information that comprises the first digest value, for controlling a reproduction of the content, by comparing the first digest value with the second digest value;
a third set of instruction codes for outputting the control information and the data, to the user terminal; and
a fourth set of instruction codes for outputting key information to further control the reproduction of the content, by determining whether the control information is valid.

10. The computer program product of claim 9, wherein the content provider comprises a first content provider that generates the content, and a second content provider that is different from the first content provider and that rates the content.

11. The computer program product of claim 10, wherein the second content provider encrypts the control information, and outputs the encrypted control information to the first content provider.

12. The computer program product of claim 11, wherein the first content provider combines the encrypted control information with the data.

13. The computer program product of claim 12, wherein the key information comprises decryption key data that is used to decrypt the encrypted control information.

14. The computer program product of claim 13, wherein the first content provider is disallowed from altering the control information.

15. The computer program product of claim 14, wherein only a user with access to both the encrypted control information and the decryption key data is allowed to decrypt the encrypted control information.

16. The computer program product of claim 9, further comprising a fifth set of instruction codes for reproducing the content if the first digest value and the second digest value are identical and the control information is determined to be valid based on the key information.

17. A system having instruction codes for providing a content that comprises control information and data from a content provider to a user terminal, the system comprising:
means for calculating a first digest value of the content by the content provider, and further for calculating a second digest value of the content on the user terminal;
means for generating the control information that comprises the first digest value, for controlling a reproduction of the content, by comparing the first digest value with the second digest value;
means for outputting the control information and the data, to the user terminal; and
means for outputting key information to further control the reproduction of the content, by determining whether the control information is valid.

18. The system of claim 17, wherein the content provider comprises a first content provider that generates the content, and a second content provider that is different from the first content provider and that rates the content.

19. The system of claim 18, wherein the second content provider encrypts the control information, and outputs the encrypted control information to the first content provider.

20. The system of claim 19, wherein the first content provider combines the encrypted control information with the data.

21. The system of claim 20, wherein the key information comprises decryption key data that is used to decrypt the encrypted control information.

22. The system of claim 21, wherein the first content provider is disallowed from altering the control information.

23. The system of claim 22, wherein only a user with access to both the encrypted control information and the decryption key data is allowed to decrypt the encrypted control information.

24. The system of claim 23, further comprising means for reproducing the content if the first digest value and the second digest value are identical and the control information is determined to be valid based on the key information.
